(19) United States
(12) Patent Application Publication
(10) Pub. No.: US 2009/0167818 A1
(43) Pub. Date: Jul. 2, 2009

(54) Highly viscous fluid discharging apparatus and highly viscous fluid discharging method

(75) Inventor: Yoshihisa Morita, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/314,475

(22) Filed: Dec. 11, 2008

(30) Foreign Application Priority Data
Dec. 27, 2007 (JP) 2007-337507

(51) Int. Cl. B41J 2/14; B41J 2/07

(52) U.S. Cl. 347/47; 347/75; 239/91; 239/102.2; 239/601; 239/1

(57) ABSTRACT

A highly viscous fluid discharging apparatus includes: a nozzle including a discharge opening having a predetermined inner volume, and a widened portion formed at a position immediately before the discharge opening and expanding from the discharge opening; a plunger capable of opening and closing the discharge opening by causing the leading-end portion of the plunger to move away from and to move towards the widened portion; and a driver configured to move the plunger in a direction of closing the discharge opening against a biasing force that biases the plunger in a direction of opening the discharge opening. During a stand-by period, the discharge opening is kept closed by an action of the plunger that is caused by the driver to press the leading-end portion onto the widened portion.

### CROSS REFERENCE TO RELATED APPLICATION

This application is based upon and claims the benefit of priority from the prior Japanese Patent Application No. 2007-337507, filed on Dec. 27, 2007, the entire contents of which are incorporated herein by reference.

### BACKGROUND OF THE INVENTION

1. Field of the Invention

The present invention relates to a highly viscous fluid discharging apparatus and a highly viscous fluid discharging method.

2. Description of the Related Art

Ink-jet printers, ink-jet image-forming apparatuses and the like that are widely used today form characters and images on a target surface by discharging a very small amount of liquid (liquid droplets) in a dot-shape under control. The mechanisms employed to enable the ink-jet technology in these printers, image-forming apparatuses and the like are widely used as common techniques today.

As these ink-jet printers, ink-jet image-forming apparatuses and the like have become popular, researches have been in progress for an application of such an ink-jet technology to the accurate drawing on a target area with a highly viscous fluid that has a much higher viscosity than a conventional ink used in the field of ink-jet printers and ink-jet image-forming apparatuses.

Japanese Unexamined Patent Application Publication No. 2006-198608 discloses a liquid-droplet discharging apparatus designed to discharge such highly viscous fluid.

In the disclosed liquid-droplet discharging apparatus, a liquid-pool chamber is formed at a position where ink passes immediately before reaching a nozzle orifice. Application of voltage to a piezoelectric element causes the displacement of the piezoelectric element. With the displacement of the piezoelectric element used as the drive source, a plunger slightly stretches toward and retracts from the liquid-pool chamber. The stretching of the plunger compresses the liquid-pool chamber and pressurizes a conductive ink, and the pressurized conductive ink is discharged through the nozzle orifice. The retracting of the plunger creates a vacuum in the liquid-pool chamber, and thus the conductive ink is supplied from an ink tank to the vacuumed liquid-pool chamber. Repetitions of these operations cause the conductive ink to be discharged as liquid-droplets.

However, the liquid-droplet discharging apparatus of the related art may have the following problem.

The liquid-pool chamber is formed at the position immediately before the nozzle orifice (discharge opening), and thus the nozzle orifice is not closed in both cases where the plunger is stretched and retracted. To put it differently, the nozzle orifice is always opened.

When a fluid used in an ink-jet type spray apparatus (discharge apparatus) has a low viscosity, the nozzle orifice can be supplied (refilled) with the low-viscosity fluid from a tank for the low-viscosity fluid just by forming a channel with, for example, a difference in levels for connecting the tank to the nozzle orifice.

By contrast, when the fluid used in the apparatus has a high viscosity, just the formation of such a channel as the one described above is not enough to supply the nozzle orifice with the highly-viscous fluid from the tank. Accordingly, the apparatus needs to be provided with pressurizing means for pumping the highly-viscous fluid, namely, for example, means for applying air pressure to the tank. To put it differently, it is necessary to make a supply with the highly-viscous fluid with pressure.

Now, in a case where the nozzle orifice is supplied with the highly viscous fluid from the tank with pressure, the highly viscous fluid is continuously pressurized so as to be directed from the tank to the nozzle orifice even while the apparatus is on stand-by to spray (discharge) the fluid, that is, even while the apparatus is on stand-by without spraying the fluid nor supplying the fluid.

For this reason, the highly viscous fluid leaks out of the always-opened nozzle orifice during the stand-by period of the apparatus. To put it differently, the apparatus has an inevitable problem of so-called dripping of the fluid. Such dripping of the fluid is problematic even when the amount of the dripped fluid is small. Furthermore, it is evident that a long stand-by time, for example, will cause an irreparable situation.

### SUMMARY OF THE INVENTION

The present invention is made in view of the problem described above, and an object of the present invention is to provide a highly viscous fluid discharging apparatus and a highly viscous fluid discharging method that are capable of preventing a highly viscous fluid from dripping while the apparatus is on stand-by.

In addition, another object of the present invention is to provide a highly viscous fluid discharging apparatus and a highly viscous fluid discharging method that are capable of preventing a highly viscous fluid from dripping while the apparatus is on standby, and that are capable of accomplishing an excellent operation of discharging the highly viscous fluid.

To achieve the above objects, a first aspect of the present invention is a highly viscous fluid discharging apparatus comprising: a nozzle including a discharge opening having a predetermined inner volume, and a widened portion formed at a position immediately before the discharge opening and expanding from the discharge opening; a plunger capable of opening and closing the discharge opening by causing a leading-end portion of the plunger to move away from and to move towards the widened portion; and a driver capable of moving the plunger in a direction of closing the discharge opening against a biasing force biasing the plunger in a direction of opening the discharge opening, wherein during a stand-by period, the discharge opening is kept closed by an action of the plunger caused by the driver to press the leading-end portion onto the widened portion.

The driver may include a piezoelectric member having laminated piezoelectric elements, and during the stand-by period, the piezoelectric member may be energized with a stand-by voltage.

The inner volume of the discharge opening may be a volume large enough to temporarily hold the highly viscous fluid of an amount substantially equivalent to an amount discharged at a single discharging action.

To achieve the above objects, a second aspect of the present invention is a highly viscous fluid discharging apparatus comprising: a nozzle including a discharge opening having a predetermined inner volume, and a widened portion formed at a position immediately before the discharge opening and expanding from the discharge opening; a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and a driver capable of moving the plunger in a direction of closing the discharge opening against a biasing force biasing the plunger in a direction of opening the discharge opening, wherein during a stand-by period, the discharge opening is kept closed by an action of the plunger caused by the driver to press the leading-end portion onto the widened portion, and immediately before a discharging action of discharging the highly viscous fluid through the discharge opening, the discharge opening is supplied with the highly viscous fluid flowing from the channel by switching off the driver and thereby allowing the biasing force to move the plunger in the direction of opening the discharge opening.

The driver may include a piezoelectric member having laminated piezoelectric elements, and during the stand-by period, the piezoelectric member may be energized with a stand-by voltage.

The driver may include a piezoelectric member having laminated piezoelectric elements, during the stand-by period, the piezoelectric member may be energized with a stand-by voltage, and during the discharging action, the piezoelectric member may be energized with a discharge pulse of a voltage lower than the stand-by voltage.

The inner volume of the discharge opening may be a volume large enough to temporarily hold the highly viscous fluid of an amount substantially equivalent to an amount discharged at a single discharging action.

To achieve the above objects, a third aspect of the present invention is a highly viscous fluid discharging apparatus comprising: a nozzle including a discharge opening having a predetermined inner volume, and a widened portion formed at a position immediately before the discharge opening and expanding from the discharge opening; a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and a driver capable of moving the plunger in a direction of closing the discharge opening against a biasing force biasing the plunger in a direction of opening the discharge opening, wherein during a stand-by period, the discharge opening is kept closed by an action of the plunger caused by the driver to press the leading-end portion onto the widened portion, the discharge opening is supplied with the highly viscous fluid flowing from the channel by switching off the driver to allow the biasing force to move the plunger in the direction of opening the discharge opening, the supplied highly viscous fluid is discharged out by an action of the plunger caused by the driver to get the leading-end portion closer to the widened portion, and immediately after the discharging action of discharging the supplied highly viscous fluid, the driver is again switched off to allow the plunger to move in the direction of opening the discharge opening.

The third aspect also can employ the aforementioned various configurations as the second aspect.

To achieve the above objects, a fourth aspect of the present invention is a highly viscous fluid discharging apparatus comprising: a nozzle including: a discharge opening having a predetermined inner volume, and a widened portion formed at a position immediately before the discharge opening and expanding from the discharge opening; a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and a driver capable of moving the plunger in a direction of closing the discharge opening against a biasing force biasing the plunger in a direction of opening the discharge opening, wherein during a stand-by period, the discharge opening is kept closed by an action of the plunger caused by the driver to press the leading-end portion onto the widened portion, the discharge opening is supplied with the highly viscous fluid flowing from the channel by switching off the driver to allow the biasing force to move the plunger in the direction of opening the discharge opening, the supplied highly viscous fluid is discharged out by an action of the plunger caused by the driver to get the leading-end portion closer to the widened portion, immediately after the discharging action of discharging the supplied highly viscous fluid, the driver is again switched off to allow the plunger to move in the direction of opening the discharge opening so that the highly viscous fluid discharged out forward by the discharging action smoothly separates away from the leading-end portion of the plunger, and thereafter, the stand-by state is restored by the action of the plunger caused by the driver.

The fourth aspect also can employ the aforementioned various configurations as the second aspect.

According to the first to fourth aspects and the configurations described above, the dripping of fluid during the stand-by period can be avoided, and a favorable operation of discharging the highly viscous fluid can be accomplished.

To achieve the above objects, a fifth aspect of the present invention is a highly viscous fluid discharging method for discharging a highly viscous fluid using a highly viscous fluid discharging apparatus, the highly viscous fluid discharging apparatus comprising: a nozzle including a discharge opening having a predetermined inner volume, and a widened portion formed at a position immediately before the discharge opening and expanding from the discharge opening; a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and a driver capable of moving the plunger in a direction of closing the discharge opening against a biasing force biasing the plunger in a direction of opening the discharge opening, the highly viscous fluid discharging method comprising: a stand-by step of keeping the discharge opening closed by an action of the plunger caused by the driver to press the leading-end portion onto the widened portion; a supplying step of supplying the discharge opening with the highly viscous fluid flowing from the channel by switching off the driver to allow the biasing force to move the plunger in the direction of opening the discharge opening; a discharging step of discharging out the highly viscous fluid supplied to the discharge opening by an action of the plunger caused by the driver to get the leading-end portion closer to the widened portion; a damping step of, immediately after discharging the supplied highly viscous fluid, again switching off the driver to allow the biasing force to move the plunger in the direction of opening the discharge opening; and a returning step of returning to the stand-by step after the damping step.

The driver may include a piezoelectric member having laminated piezoelectric elements, during the stand-by step, the piezoelectric member may be energized with a stand-by voltage, during the supplying step, application of voltage to the piezoelectric member may be ceased, in the discharging step, the piezoelectric member may be energized with a discharge pulse of a voltage lower than the stand-by voltage, during the damping step, application of voltage to the piezoelectric member may be ceased, and after the damping step, the piezoelectric member may be again energized with the stand-by voltage.

The supplying step may continue only for a length of time needed to supply the discharge opening from the channel with the highly viscous fluid of an amount substantially equivalent to an amount discharged in a single discharging action.

The damping step may continue for a length of time needed to allow the highly viscous fluid discharged out forward in the discharging step to smoothly separate away from the leading-end portion of the plunger.

According to the fifth aspect and the configurations described above, not only the dripping of fluid during the stand-by period can be avoided, but also a favorable operation of discharging the highly viscous fluid can be accomplished.

### BRIEF DESCRIPTION OF THE DRAWINGS

FIG. 1 is a schematic configuration diagram illustrating a highly viscous fluid discharging apparatus according to an embodiment of the present invention.

FIG. 2 is an enlarged sectional diagram of a principal portion of the highly viscous fluid discharging apparatus illustrated in FIG. 1. However, a channel of the highly viscous fluid therein and a method of fixing a nozzle and a tubular body differ from those in the FIG. 1.

FIG. 3 is a developed view illustrating a nozzle and a plunger according to the embodiment of the present invention.

FIG. 4 is a graph illustrating the transition of the voltage applied to a driver (piezoelectric member) according to the embodiment of the present invention. A period a represents a stand-by state (stand-by step); periods b1 and b2 each represents a supplying state (supplying step); a period c represents a discharging state (discharging step); a period d represents a damping state (damping step); periods e1 and e2 each represents a returning state (returning step).

FIG. 5A is a diagram describing the relationship between the nozzle and the plunger during the period a in FIG. 4, i.e., in the stand-by state (in the stand-by step).

FIG. 5B is a diagram describing the relationship between the nozzle and the plunger, as well as describing the condition of the highly viscous fluid during the periods b1 and b2 in FIG. 4, i.e., in the supplying state (in the supplying step).

FIG. 5C is a diagram describing the relationship between the nozzle and the plunger, as well as describing the condition of the highly viscous fluid during the period c in FIG. 4, i.e., in the discharging state (in the discharging step).

FIG. 5D is a diagram describing the relationship between the nozzle and the plunger, as well as describing the condition of the highly viscous fluid during the period d in FIG. 4, i.e., in the damping state (in the damping step).

FIG. 5E is a diagram describing the relationship between the nozzle and the plunger, as well as describing the condition of the highly viscous fluid in a flying state (in a flying step).

FIG. 5F is a diagram describing the relationship between the nozzle and the plunger during the periods e1 and e2 in FIG. 4, i.e., in the returning state (in the returning step).

### DESCRIPTION OF THE PREFERRED EMBODIMENT

An embodiment of the present invention will be described below with reference to the drawings. Identical or similar reference numerals are given to those parts that are identical or similar to each other in the drawings.

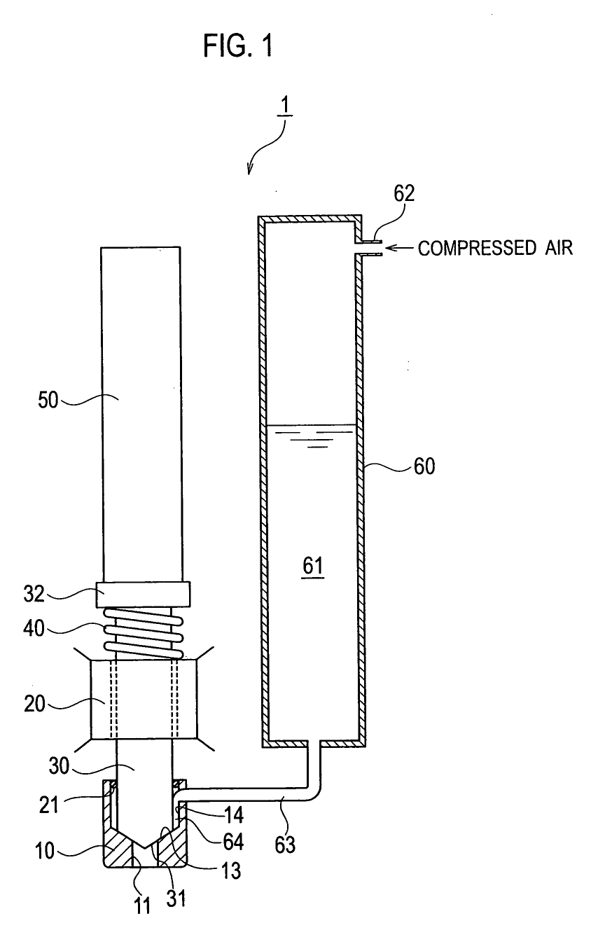

FIG. 1 is a schematic configuration diagram illustrating a highly viscous fluid discharging apparatus 1 according to an embodiment of the present invention. The highly viscous fluid discharging apparatus 1 includes a nozzle 10, a tubular body 20, a plunger 30, a biasing member 40, a driver 50, and a tank 60 for a highly viscous fluid. The nozzle 10 is disposed on the extended line of the axis of the tubular body 20. The plunger 30 is disposed at the inner side of the tubular body 20 so as to extend along the axis of the tubular body 20. The biasing member 40 biases the plunger 30 in a direction such that the plunger 30 is made to move away from the nozzle 10. The driver 50 actuates the plunger 30 so as to make the plunger 30 move towards the nozzle 10.

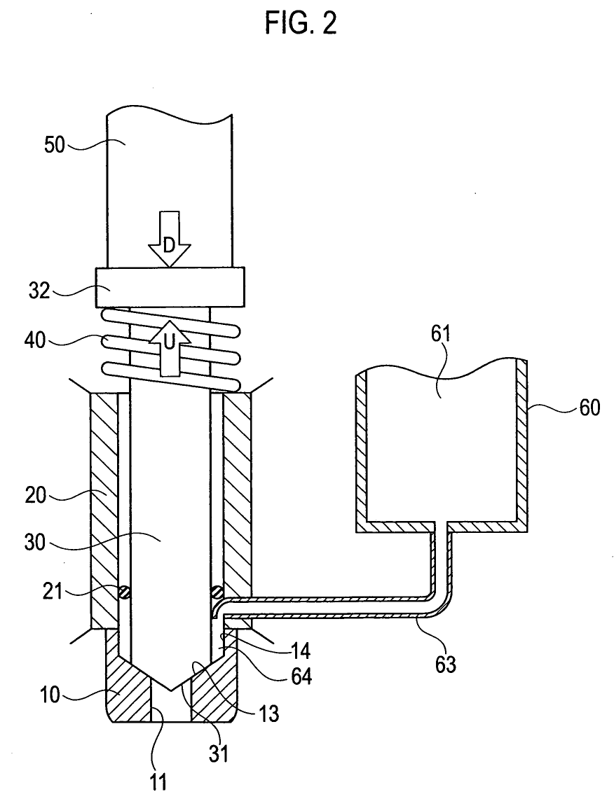

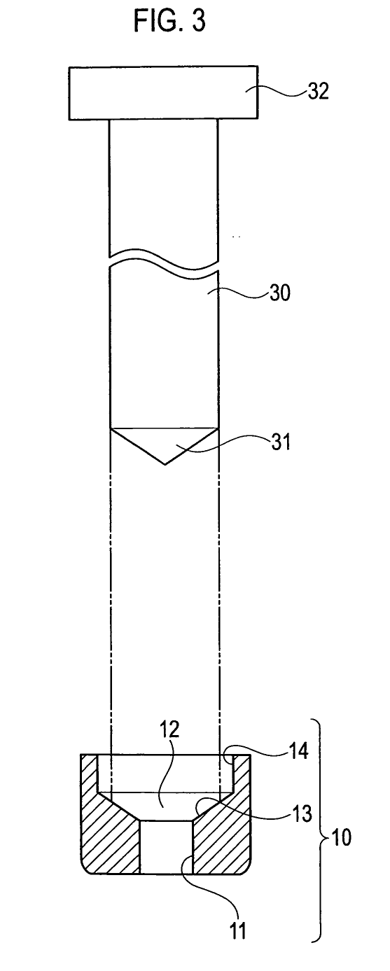

FIG. 2 is an enlarged sectional diagram of a principal portion of the highly viscous fluid discharging apparatus 1 illustrated in FIG. 1. However, a method of fixing the nozzle 10 and the tubular body 20, as well as a structure of a channel 60 of the highly viscous fluid 61 in FIG. 2, differ from those in the FIG. 1 (detailed description for the differences will be given later). FIG. 3 is a developed view illustrating the nozzle 10 and the plunger 30.

In the configuration illustrated in FIG. 1, the tubular body 20 is fixed to an unillustrated frame. The nozzle 10 is also fixed to the unillustrated frame, independently of the tubular body 20, at a position located on the extended line of the axis of the tubular body 20 and separated away from the tubular body 20 by a predetermined length. On the other hand, in the configuration illustrated in FIG. 2, the tubular body 20 fixed to the unillustrated frame is formed to be longer than the length of the tubular body 20 in FIG. 1, and the nozzle 10 in FIG. 2 is attached directly to the lower end of the tubular body 20. In this case, the nozzle 10 may be, for example, screwed to the lower end of the tubular body 20.

In the design of the highly viscous fluid discharging apparatus 1, it is selectable as needed whether the nozzle 10 is fixed to the frame independently of the tubular body 20 as illustrated in FIG. 1, or the nozzle 10 is directly fixed to the lower end of the tubular body 20 as illustrated in FIG. 2. In this embodiment, any one of these two options can be selected as needed.

As FIGS. 1 to 3 illustrate, a discharge opening 11 with a predetermined inner volume is formed in the nozzle 10. The nozzle 10 includes, at a position immediately before (above in the drawings) the discharge opening 11, a widened portion 12 widening from the discharge opening 11. In addition, at a position immediately before (above in the drawings) the widened portion 12, a tubular portion 14 is formed in the nozzle 10.

The discharge opening 11 has an inner volume that is capable of holding, temporarily, the highly viscous fluid 61 of an amount that is to be discharged in a single discharging action. The discharge opening 11 is formed into a cylindrical shape with a predetermined diameter and a predetermined length. The shape of the discharge opening 11, however, does not have to be cylindrical. Instead, the discharge opening 11 can be formed to have any appropriate sectional shape but a circular one as needed.

The widened portion 12 includes an inclined surface 13 that expands from the inner circumferential surface of the discharge opening 11 to the inner circumferential surface of the tubular portion 14. The widened portion 12 is formed into a conical shape with an opening located at the center and communicatively connected to the discharge opening 11. The shape of the widened portion 12, however, does not have to be conical. Instead, the widened portion 12 can be formed to have any appropriate sectional shape but a circular one as needed.

The tubular portion 14 is designed to accommodate a part of the plunger 30 from the leading end thereof to a position a predetermined length away from the leading end. The tubular portion 14 is formed, for example, to have a shape of a cylinder. The diameter and the length of the cylindrical tubular portion 14 are predetermined so as to be sufficient to accommodate the part of the plunger 30. The shape of the tubular portion 14, however, does not have to be cylindrical. Instead, the tubular portion 12 can be formed to have any appropriate sectional shape other than a circular one if necessary.

The tubular body 20 includes a tubular inner circumferential surface, and is formed, for instance, into a cylindrical shape. The shape of the tubular body 20, however, does not have to be cylindrical. Instead, the tubular body 20 can be formed to have any appropriate sectional shape other than a circular one if necessary. In addition, the member that performs the function of the tubular body 20 does not have to be formed into a tubular shape. Instead, the member can be formed to be a support member of any appropriate shape as long as the member can support the plunger 30 so that the plunger 30 moves back and force (move up and down in the drawings).

The plunger 30 is a column-shaped member that is accommodated in the tubular body 20. The plunger 30 includes an inclined surface 31 formed at the leading-end portion of the plunger 30 (i.e., at the lower end portion of the plunger 30 in the drawings). The inclined surface 31 corresponds to the inclined surface 13 formed in the widened portion 12 of the nozzle 10.

The leading-end portion of the plunger 30 is formed, for example, into the conical-shape inclined surface 31 that corresponds to the conical-shape inclined surface 13. The leading-end portion of the plunger 30, however, does not have to be formed into a conical shape. Instead, the leading-end portion of the plunger 30 can be formed to have any appropriate sectional shape other than a circular one so as to fit the corresponding shape of the widened portion 12 of the nozzle 10.

The plunger 30 includes, at its upper end portion, a head portion 32 that expands in the radial direction of the plunger 30.

The biasing member 40 biases the plunger 30 to a side so as to open the discharge opening 11 (in the direction indicated by an arrow U in FIG. 2). A coil spring, for example, is provided to serve as the biasing member 40. Such coil spring is disposed so as to surround the plunger 30 in a space between the bottom surface of the head portion 32 of the plunger 30 and the top surface of the tubular body 20.

The biasing member 40 thus supported by the top surface of the tubular body 20 acts on the head portion 32 of the plunger 30, and biases the inclined surface 31 at the leading-end portion of the plunger 30 in a direction such that the inclined surface 31 is moved away from the inclined surface 13 of the widened portion 12 of the nozzle 10.

When the driver 50, which will be described later, is in the OFF state, that is, when the driver 50 is not energized (is switched off) (i.e., no voltage is applied to the driver 50), the biasing member 40 causes the inclined surface 31 at the leading-end portion of the plunger 30 to be positioned a predetermined height (for example, approximately 30 μm) above the inclined surface 13 of the widened portion 12 of the nozzle 10.

The driver 50 actuates the plunger 30 so that the plunger 30 moves in a direction of closing the discharge opening 11 (in the direction indicated by an arrow D in FIG. 2). For example, a piezoelectric member including multiple piezoelectric elements stacked in layers (laminated piezoelectric elements) serves as the driver 50. The upper end portion of the driver 50 is fixed to an unillustrated frame while the position of the driver thus fixed is predetermined as follows. When the driver 50 is in the OFF state, that is, when the driver 50 is not energized (i.e., no voltage is applied to the driver 50), the lower end portion of the driver 50 is in contact with the top surface of the head portion 32 of the plunger 30.

In essence, when the driver 50 is in the OFF state so as not to be energized (i.e., no voltage is applied to the driver 50), the lower end portion of the driver 50 with its upper end portion fixed to the frame at a predetermined position is positioned in a way to be contact with the top surface of the head portion 32 of the plunger 30. At this time, the inclined surface 31 at the leading-end portion of the plunger 30 is positioned a predetermined height (for example, approximately 30 μm) above the inclined surface 13 of the widened portion 12 of the nozzle 10.

When the driver 50 in this state is energized, the driver 50 pushes the head portion 32 of the plunger 30 downwards. The plunger 30 thus pushed downwards is actuated to move in the direction of closing the discharge opening 11. The stroke of the action of the plunger 30 at this time is variable depending on the magnitude of the voltage with which the driver is energized (i.e., the voltage that is applied to the driver 50).

Now, suppose a case where the driver 50 is energized (applied) with a predetermined stand-by voltage. The actuation stroke of the plunger 30 in this case is designed to be a length (for example, 30 μm) equivalent to a height from the inclined surface 13 of the widened portion 12 of the nozzle 10 to the inclined surface 31 at the leading-end portion of the plunger 30 at the time when the driver 50 is in the OFF state to be not energized (i.e., no voltage is applied to the driver 50). Specifically, the stand-by voltage is set, for example, at 100 V.

Accordingly, when the driver 50 is energized (applied) with a predetermined stand-by voltage (for example, 100 V), the plunger is actuated to move downwards so as to make the inclined surface 31 at the leading-end portion of the plunger 30 is pressed onto (brought into close contact with) the inclined surface 13 of the widened portion 12 of the nozzle 10.

The tank 60 is provided to store the highly viscous fluid 61. An introduction pipe channel 62 for compressed air is provided near the upper end portion of the tank 60. Compressed air is introduced into the tank 60 through the introduction pipe channel 62, and pressurizes the highly viscous fluid 61 stored in the tank 60.

One of the two ends of the channel 63 for the highly viscous fluid 61 is connected to the lower end portion of the tank 60. The other end of the channel 63 is connected to the tubular portion 14 of the nozzle 10 (in the case illustrated in FIG. 1) or to the lower end portion of the tubular body 20 (in the case illustrated in FIG. 2). The highly viscous fluid 61 that is supplied (pumped) from the tank 60 to the tubular portion 14 of the nozzle 10 through the channel 63, is made to pass through a channel 64 formed between the inner surface of the tubular portion 14 of the nozzle 10 and the circumferential surface of the plunger 30, and then supplied (pumped) to the widened portion 12 of the nozzle 10.

Accordingly, as FIG. 1 illustrates, a seal ring 21 is placed near the upper end portion of the tubular portion 14 of the nozzle 10. The seal ring 21 herein provides sealing between the tubular portion 14 and the circumferential surface of the plunger 30 so that the highly viscous fluid 61 supplied (pumped) to the tubular portion 14 from the tank 60 via the channel 63 cannot leak out of the upper end portion of the tubular portion 14 through the gap between the tubular portion 14 and the circumferential surface of the plunger 30. And also, as FIG. 2 illustrates, a seal ring 21 is placed near the lower end portion of the tubular body 20. The seal ring 21 herein provides sealing between the inner surface of the tubular body 20 and the circumferential surface of the plunger 30 so that the highly viscous fluid 61 supplied (pumped) to the tubular portion 14 from the tank 60 via the channel 63 cannot enter the inner side of the tubular body 20 through the gap between the inner surface of the tubular body 20 and the circumferential surface of the plunger 30.

When the driver 50 is in the ON state to be energized (applied) with a predetermined stand-by voltage (for example, 100 V), the inclined surface 31 at the leading-end portion of the plunger 30 is in close contact with the inclined surface 13 of the widened portion 12 of the nozzle 10. Accordingly, the communication between the discharge opening 11 of the nozzle 10 and the channel 64 of the tubular portion 14 is cut off (prevented), that is, the discharge opening 11 is closed, because the widened portion 12 located in between is closed.

When the discharge opening 11 is closed, the highly viscous fluid 61 supplied (pumped) from the tank 60 via the channel 63 to the tubular portion 14 of the nozzle 10 cannot flow out from the channel 64 of the tubular portion 14 to the discharge opening 11. As a consequence, the discharge opening 11 is left substantially with no highly viscous fluid 61 therein.

In contrast, when the driver 50 is in the OFF state to be energized (applied) with no voltage, the biasing force from the biasing member 40 acts on the plunger 30. Thereby, the inclined surface 31 at the leading-end portion of the plunger 30 is separated away from the inclined surface 13 of the widened portion 12 of the nozzle 10. Accordingly, the communication between the discharge opening 11 of the nozzle 10 and the channel 64 of the tubular portion 14 is secured, that is, the discharge opening 11 is opened, because the widened portion 12 located in between is opened.

When the discharge opening 11 is opened, the highly viscous fluid 61 supplied (pumped) from the tank 60 via the channel 63 to the tubular portion 14 of the nozzle 10 can flow out from the channel 64 of the tubular portion 14 to the discharge opening 11 without any problem. As a consequence, the discharge opening 11 is kept supplied with the highly viscous fluid 61.

The voltage (driving voltage) applied to the driver 50 is turned ON and OFF in accordance with a waveform (driving waveform) that will be described below.

Next, the operation of the highly viscous fluid discharging apparatus 1 of this embodiment will be described.

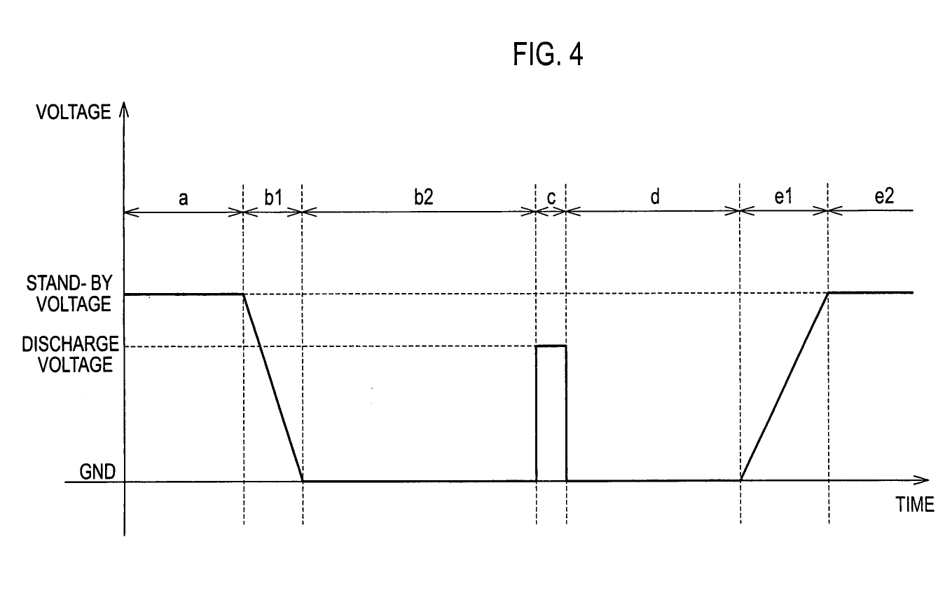

In a stand-by state (a stand-by step), the driver 50 is energized with a predetermined stand-by voltage (see the period a in FIG. 4). A voltage of 100 V, for example, may be applied to the driver 50 as the stand-by voltage.

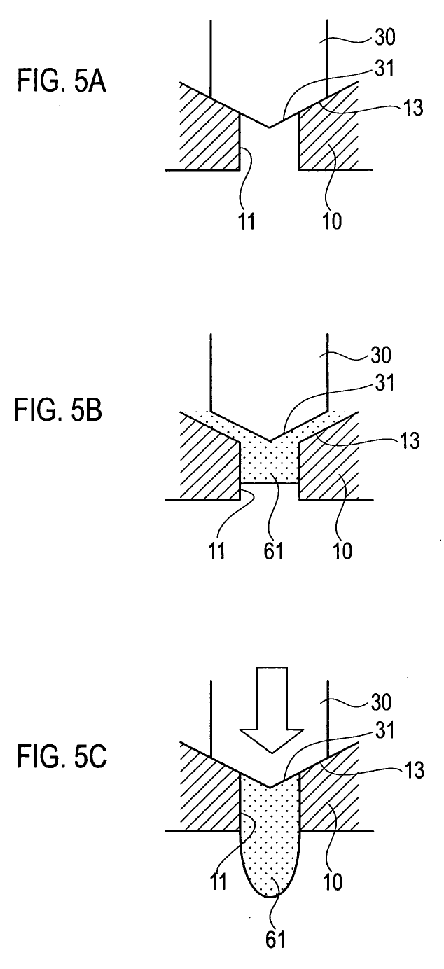

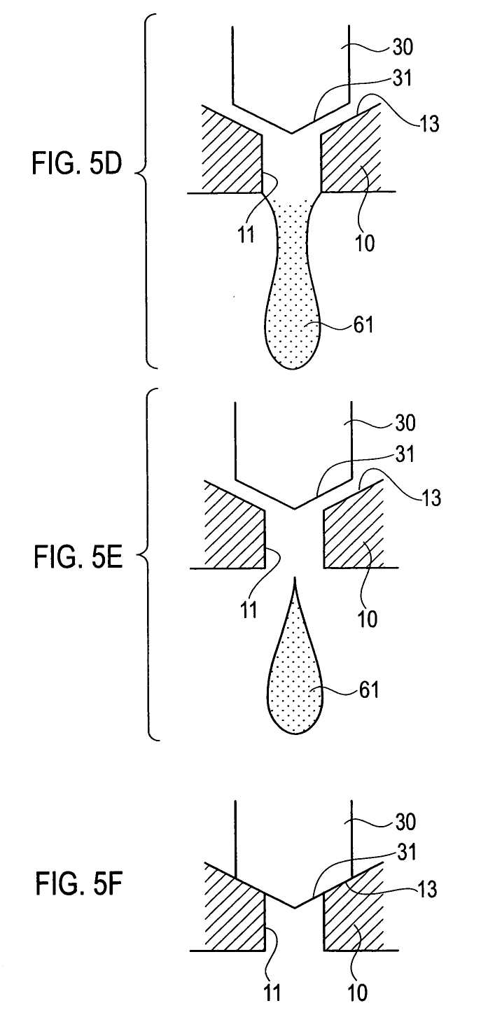

Accordingly, in the stand-by state, the driver 50 actuates the plunger 30, so that the inclined surface 31 of the plunger 30 is pressed onto the inclined surface 13 of the widened portion 12 of the nozzle 10. As a consequence, the discharge opening 11 is kept closed (see FIG. 5A).

Subsequently, the voltage applied to the driver 50 is lowered down to the GND level (see the period b1 in FIG. 4), and is kept at 0 V (see the period b2 in FIG. 4).

Accordingly, the driver 50 is turned OFF, and the biasing force from the biasing member 40 makes the plunger 30 move in a direction of opening the discharge opening 11. As a consequence, the discharge opening 11 is supplied with the highly viscous fluid 61 flowing from the channel 64 of the tubular portion 14 (see FIG. 5B).

Subsequently, the driver 50 is energized with a predetermined discharge voltage (see the period c in FIG. 4). A discharge pulse of a lower voltage than the stand-by voltage, for example, is applied to the driver 50 as the discharge voltage, for the following reason. If the discharge voltage is set at the same level as the stand-by voltage, the inclined surface 31 at the leading-end portion of the plunger 30 hits intensively the inclined surface 13 of the widened portion 12 of the nozzle 10, which may possibly damage the nozzle 10 and result in a shorter material life of the nozzle 10.

With the application of the discharge voltage, the driver 50 actuates the plunger 30 so that the inclined surface 31 at the leading-end portion of the plunger 30 gets closer (rapidly gets closer) to the inclined surface 13 of the widened portion 12 of the nozzle 10. As a consequence, the highly viscous fluid 61 that has just been supplied in the discharge opening 11 is discharged through the discharge opening 11 (see FIG. 5C). To be more specific, the highly viscous fluid 61 is hit and pushed by the inclined surface 31 at the leading-end portion of the plunger 30 so as to be discharged out through the discharge opening 11.

Along with the fall of the discharge pulse, the voltage of the driver 50 is steeply lowered down to the GND level, and is kept in that state (0 V) (see the period d in FIG. 4).

Accordingly, the driver 50 is turned OFF, and the biasing force from the biasing member 40 makes the plunger 30 move in the direction of opening the discharge opening 11 (see FIG. 5D). As a consequence, the rear end portion of the highly viscous fluid 61 that is being discharged forward through the discharge opening 11 can be smoothly separated away from the leading-end portion (the inclined surface 31 at the leading-end portion) of the plunger 30.

When the rear end portion of the highly viscous fluid 61 leaves the discharge opening 11 and the whole highly viscous fluid 61 starts flying (see FIG. 5E), a voltage is applied to the driver 50 and raised up to the predetermined stand-by voltage (see the period e1 in FIG. 4). Then, the voltage applied to the driver 50 is kept at the stand-by voltage (see the period e2 in FIG. 4).

Accordingly, the driver 50 actuates the plunger 30, and the inclined surface 31 at the leading-end portion is pressed onto the inclined surface 13 of the widened portion 12 of the nozzle 10 so that the stand-by state is restored (see FIG. 5F).

Next, a highly viscous fluid discharging method according to an embodiment of the present invention will be described.

The highly viscous fluid discharging method is a method of discharging the highly viscous fluid 61 by means of the highly viscous fluid discharging apparatus 1 of the above-described embodiment, and includes the following steps.

(1) A stand-by step: The driver 50 actuates the plunger 30 so that the inclined surface 31 at the leading-end portion of the plunger 30 is pressed onto the inclined surface 13 of the widened portion 12 of the nozzle 10, whereby the discharge opening 11 is kept closed (see FIG. 5A).

During this stand-by step, the driver 50 is energized with the stand-by voltage (see the period a in FIG. 4).

(2) A supplying step: The driver 50 is turned OFF, and the biasing force from the biasing member 40 makes the plunger 30 move in the direction of opening the discharge opening 11, whereby the discharge opening 11 is supplied with the highly viscous fluid 61 flowing from the channel 64 of the tubular portion 14 (see FIG. 5B).

During this supplying step, the voltage of the driver 50 is turned OFF (see the period b1 in FIG. 4). This supplying step continues for a length of time needed to supply the discharge opening 11 with the highly viscous fluid 61 flowing from the channel 64 of the tubular portion 14 and being substantially equivalent to the amount discharged at a single discharging action (see the period b2 in FIG. 4).

(3) A discharging step: The driver 50 actuates the plunger 30 so that the inclined surface 31 at the leading-end portion of the plunger 30 gets closer (in the direction indicated by the arrow in FIG. 5C) (rapidly get closer) to the inclined surface 13 of the widened portion 12 of the nozzle 10, whereby the highly viscous fluid 61 that has just been supplied in the discharge opening 11 is discharged through the discharge opening 11 (see FIG. 5C).

During this discharging step, the driver 50 is energized with the discharge pulse of a voltage that is lower than the stand-by voltage (see the period c in FIG. 4).

(4) A damping step: Immediately after the discharging, the driver 50 is turned OFF, and the biasing force of the biasing member 40 makes the plunger 30 move in the direction of opening the discharge opening 11. As a consequence, the rear-end portion of the highly viscous fluid 61 that is being discharged forward through the discharge opening 11 can be smoothly separated away from the leading-end portion (the inclined surface 31 at the leading-end portion) of the plunger 30 (see FIG. 5D).

During this damping step, the voltage of the driver 50 is turned off (see the period d in FIG. 4). This damping step continues for a length of time needed for the highly viscous fluid 61 that is being discharged forward in the discharging step to be smoothly separated away from the leading-end portion (the inclined surface 31 at the leading-end portion) of the plunger 30 (see the period d in FIG. 4).

In this damping step, the rear end of the highly viscous fluid 61 leaves the leading-end portion (the inclined surface 31 at the leading-end portion) of the plunger 30, and then the whole highly viscous fluid 61 leaves the discharge opening 11. Thereby, the highly viscous fluid 61 starts flying (see FIG. 5E).

(5) Subsequently, after the damping step (after the highly viscous fluid 61 starts to fly), the operation of the highly viscous fluid discharging apparatus 1 returns to the stand-by step (see FIG. 5F). To be more specific, the driver 50 is energized again with the stand-by voltage (see periods e1 and e2 in FIG. 4).

Note that the discharge pulse in the above-described embodiment is a pulse of a rectangular-form wave. However, the waveform is not limited to such waveform for the discharge pulse. Instead, a pulse of a triangular-form wave or a pulse of a trapezoidal-form wave can be employed as the discharge pulse.

In general, what is important to make a highly viscous fluid fly in a favorable and proper fashion is the shape of the highly viscous fluid 61 in the flying state (the flying step). It is especially important that the rear portion of the flying highly viscous fluid 61 has only a small amount of “tremor.” For this reason, the action of the plunger 30 at the end of the discharging is more important than the action of the plunger 30 at the start of the discharging. To solve this, the rising of the discharge pulse may be sloping relatively gently like the hypotenuse of a right triangle, but it is essential that the falling of the discharge pulse be as steep as almost vertical.

According to the above-described highly viscous fluid discharging apparatus and the above-described highly viscous fluid discharging method, the “dripping of the fluid,” that is, the flowing-out of the highly viscous fluid 61 through the discharge opening 11 during the stand-by period can be prevented.

In addition, since the discharge opening 11 is supplied with the highly viscous fluid 61 of just the necessary amount immediately before the discharging, the possibility of wasting the highly viscous fluid 61 can be precluded.

Moreover, the provision of the damping time (the damping step) immediately after the discharging ensures to perform the “retreating” action of the plunger 30 (the biasing force of the biasing member 40 moves the plunger 30 in the direction of opening the discharge opening 11). As a consequence, a favorable discharging state can be accomplished.

Furthermore, the flying speed of the highly viscous fluid 61 to be discharged can be controlled to a certain extent by controlling the form of the discharge pulse.

As has been described thus far, the use of the highly viscous fluid discharging apparatus and the highly viscous fluid discharging method according to the embodiments of the present invention allows a highly viscous fluid to form a favorable shape, specifically, a shape with a small amount of “tremors” at its rear portion. As a result, a highly viscous fluid, such as a solder paste, can be made to fly in a favorable and proper fashion, thereby forming an accurate dot at a predetermined portion on a target object.

A highly viscous fluid discharging apparatus and a highly viscous fluid discharging method according to the embodiment of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiment of the present invention are only a list of optimum effects achieved by the present invention. Hence, the effects of the present invention are not limited to those described in the embodiment of the present invention.

What is claimed is:

1. A highly viscous fluid discharging apparatus comprising:
a nozzle including
a discharge opening having a predetermined inner volume, and
a widened portion formed at a position immediately before the discharge opening and expanding from the discharge opening;
a plunger capable of opening and closing the discharge opening by causing a leading-end portion of the plunger to move away from and to move towards the widened portion; and
a driver capable of moving the plunger in a direction of closing the discharge opening against a biasing force biasing the plunger in a direction of opening the discharge opening,
wherein during a stand-by period, the discharge opening is kept closed by an action of the plunger caused by the driver to press the leading-end portion onto the widened portion.

2. The highly viscous fluid discharging apparatus according to claim 1, wherein
the driver includes a piezoelectric member having laminated piezoelectric elements, and
during the stand-by period, the piezoelectric member is energized with a stand-by voltage.

3. The highly viscous fluid discharging apparatus according to claim 1, wherein the inner volume of the discharge opening is a volume large enough to temporarily hold the highly viscous fluid of an amount substantially equivalent to an amount discharged at a single discharging action.

4. A highly viscous fluid discharging apparatus comprising:
a nozzle including
a discharge opening having a predetermined inner volume, and
a widened portion formed at a position immediately before the discharge opening and expanding from the discharge opening;
a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and
a driver capable of moving the plunger in a direction of closing the discharge opening against a biasing force biasing the plunger in a direction of opening the discharge opening,
wherein during a stand-by period, the discharge opening is kept closed by an action of the plunger caused by the driver to press the leading-end portion onto the widened portion, and
immediately before a discharging action of discharging the highly viscous fluid through the discharge opening, the the discharge opening is supplied with the highly viscous fluid flowing from the channel by switching off the driver and thereby allowing the biasing force to move the plunger in the direction of opening the discharge opening.

5. The highly viscous fluid discharging apparatus according to claim 4, wherein
the driver includes a piezoelectric member having laminated piezoelectric elements, and
during the stand-by period, the piezoelectric member is energized with a stand-by voltage.

6. The highly viscous fluid discharging apparatus according to claim 4, wherein
the driver includes a piezoelectric member having laminated piezoelectric elements,
during the stand-by period, the piezoelectric member is energized with a stand-by voltage, and
during the discharging action, the piezoelectric member is energized with a discharge pulse of a voltage lower than the stand-by voltage.

7. The highly viscous fluid discharging apparatus according to claim 4, wherein the inner volume of the discharge opening is a volume large enough to temporarily hold the highly viscous fluid of an amount substantially equivalent to an amount discharged at a single discharging action.

8. A highly viscous fluid discharging apparatus comprising:
a nozzle including
a discharge opening having a predetermined inner volume, and
a widened portion formed at a position immediately before the discharge opening and expanding from the discharge opening;
a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and
a driver capable of moving the plunger in a direction of closing the discharge opening against a biasing force biasing the plunger in a direction of opening the discharge opening,
wherein during a stand-by period, the discharge opening is kept closed by an action of the plunger caused by the driver to press the leading-end portion onto the widened portion,
the discharge opening is supplied with the highly viscous fluid flowing from the channel by switching off the driver to allow the biasing force to move the plunger in the direction of opening the discharge opening,
the supplied highly viscous fluid is discharged out by an action of the plunger caused by the driver to get the leading-end portion closer to the widened portion, and
immediately after the discharging action of discharging the supplied highly viscous fluid, the driver is again switched off to allow the plunger to move in the direction of opening the discharge opening.

9. The highly viscous fluid discharging apparatus according to claim 8, wherein
the driver includes a piezoelectric member having laminated piezoelectric elements, and
during the stand-by period, the piezoelectric member is energized with a stand-by voltage.

10. The highly viscous fluid discharging apparatus according to claim 8, wherein
the driver includes a piezoelectric member having laminated piezoelectric elements,
during the stand-by period, the piezoelectric member is energized with a stand-by voltage, and
during the discharging action, the piezoelectric member is energized with a discharge pulse of a voltage lower than the stand-by voltage.

11. The highly viscous fluid discharging apparatus according to claim 8, wherein the inner volume of the discharge opening is a volume large enough to temporarily hold the highly viscous fluid of an amount substantially equivalent to an amount discharged at a single discharging action.

12. A highly viscous fluid discharging apparatus comprising:
a nozzle including:
a discharge opening having a predetermined inner volume, and
a widened portion formed at a position immediately before the discharge opening and expanding from the discharge opening;
a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and
a driver capable of moving the plunger in a direction of closing the discharge opening against a biasing force biasing the plunger in a direction of opening the discharge opening,
wherein during a stand-by period, the discharge opening is kept closed by an action of the plunger caused by the driver to press the leading-end portion onto the widened portion,
the discharge opening is supplied with the highly viscous fluid flowing from the channel by switching off the driver to allow the biasing force to move the plunger in the direction of opening the discharge opening,
the supplied highly viscous fluid is discharged out by an action of the plunger caused by the driver to get the leading-end portion closer to the widened portion,
immediately after the discharging action of discharging the supplied highly viscous fluid, the driver is again switched off to allow the plunger to move in the direction of opening the discharge opening so that the highly viscous fluid discharged out forward by the discharging action smoothly separates away from the leading-end portion of the plunger, and
thereafter, the stand-by state is restored by the action of the plunger caused by the driver.

13. The highly viscous fluid discharging apparatus according to claim 12, wherein
the driver includes a piezoelectric member having laminated piezoelectric elements, and
during the stand-by period, the piezoelectric member is energized with a stand-by voltage.

14. The highly viscous fluid discharging apparatus according to claim 12, wherein
the driver includes a piezoelectric member having laminated piezoelectric elements,
during the stand-by period, the piezoelectric member is energized with a stand-by voltage, and
during the discharging action, the piezoelectric member is energized with a discharge pulse of a voltage lower than the stand-by voltage.

15. The highly viscous fluid discharging apparatus according to claim 12, wherein the inner volume of the discharge opening is a volume large enough to temporarily hold the highly viscous fluid of an amount substantially equivalent to an amount discharged at a single discharging action.

16. A highly viscous fluid discharging method for discharging a highly viscous fluid using a highly viscous fluid discharging apparatus,
the highly viscous fluid discharging apparatus comprising:
a nozzle including
a discharge opening having a predetermined inner volume, and
a widened portion formed at a position immediately before the discharge opening and expanding from the discharge opening;
a plunger capable of opening and closing the discharge opening by causing a leading-end portion of the plunger to move away from and to move towards the widened portion, the plunger securing and preventing communication between the discharge opening and a channel for the highly viscous fluid supplied from a tank, by opening and closing the discharge opening; and
a driver capable of moving the plunger in a direction of closing the discharge opening against a biasing force biasing the plunger in a direction of opening the discharge opening,
the highly viscous fluid discharging method comprising:
a stand-by step of keeping the discharge opening closed by an action of the plunger caused by the driver to press the leading-end portion onto the widened portion;
a supplying step of supplying the discharge opening with the highly viscous fluid flowing from the channel by switching off the driver to allow the biasing force to move the plunger in the direction of opening the discharge opening;
a discharging step of discharging out the highly viscous fluid supplied to the discharge opening by an action of the plunger caused by the driver to get the leading-end portion closer to the widened portion;
a damping step of, immediately after discharging the supplied highly viscous fluid, again switching off the driver to allow the biasing force to move the plunger in the direction of opening the discharge opening; and
a returning step of returning to the stand-by step after the damping step.

17. The highly viscous fluid discharging method according to claim 16, wherein
the driver includes a piezoelectric member having laminated piezoelectric elements,
during the stand-by step, the piezoelectric member is energized with a stand-by voltage,
during the supplying step, application of voltage to the piezoelectric member is ceased,
in the discharging step, the piezoelectric member is energized with a discharge pulse of a voltage lower than the stand-by voltage,
during the damping step, application of voltage to the piezoelectric member is ceased, and
after the damping step, the piezoelectric member is again energized with the stand-by voltage.

18. The highly viscous fluid discharging method according to claim 16, wherein the supplying step continues only for a length of time needed to supply the discharge opening from the channel with the highly viscous fluid of an amount substantially equivalent to an amount discharged in a single discharging action.

19. The highly viscous fluid discharging method according to claim 16, wherein the damping step continues for a length of time needed to allow the highly viscous fluid discharged out forward in the discharging step to smoothly separate away from the leading-end portion of the plunger.
